(19) United States
(12) Patent Application Publication
(10) Pub. No.: US 2017/0221005 A1
(43) Pub. Date: Aug. 3, 2017

(54) QUANTIFYING JOB POSTER VALUE

(71) Applicant: LinkedIn Corporation, Mountain View, CA (US)

(72) Inventors: Krishnaram Kenthapadi, Sunnyvale, CA (US); Yiqun Liu, Sunnyvale, CA (US); Bo Zhao, Redwood City, CA (US); David Hardtke, Oakland, CA (US)

(21) Appl. No.: 15/014,985

(22) Filed: Feb. 3, 2016

(51) Int. Cl. G06Q 10/10

(52) U.S. Cl. CPC G06Q 10/1053; G06Q 50/01

(57) ABSTRACT

A JPV calculator is described for quantifying a job poster value for a particular job posting at a certain point in time, in the context of an on-line social network system. A job poster value (JPV) represents a value that is still owed to the associated job posting entity at a certain point in time with respect to a particular job posting. The JPV calculator determines JPV by taking into account the temporal job statistics for a job. The job poster value drops as the job posting gets more applications from members of the on-line social network system.

### TECHNICAL FIELD

This application relates to the technical fields of software and/or hardware technology and, in one example embodiment, to system and method to determine a job poster value for a job posting in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

An on-line social network may store include one or more components for facilitating job-related searches for members. The on-line social network system may be configured to match member profiles with job postings. Those job postings that have been identified as potentially being of interest to a member represented by a particular member profile are presented to the member on a display device for viewing.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to determine a job poster value for a job posting in an on-line social network system may be implemented;

FIG. 2 is block diagram of a system to determine a job poster value for a job posting in an on-line social network system, in accordance with one example embodiment;

FIG. 3 is a flow chart illustrating a method to determine a job poster value for a job posting in an on-line social network system, in accordance with an example embodiment;

FIG. 4 shows a screen representing a portion of a web page that includes a subset selected from a set of recommended jobs, in accordance with an example embodiment;

FIG. 5 shows a screen representing a portion of a web page that includes additional job postings, in accordance with an example embodiment; and

FIG. 6 is a diagrammatic representation of an example machine in the form of a computer system within which a set of instructions, for causing the machine to perform any one or more of the methodologies discussed herein, may be executed.

### DETAILED DESCRIPTION

A method and system to determine a job poster value for a job posting in an on-line social network system is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrases “an on-line social networking application” and “an on-line social network system” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network. Members who are connected in the context of a social network may be termed each other's “connections” and their respective profiles are associated with respective connection links indicative of these two profiles being connected.

The profile information of a social network member may include various information such as, e.g., the name of a member, current and previous geographic location of a member, current and previous employment information of a member, information related to education of a member, information about professional accomplishments of a member, publications, patents, etc. The profile information of a social network member may also include information about the member's professional skills. A particular type of information that may be present in a profile, such as, e.g., company, industry, job position, etc., is referred to as a profile attribute. A profile attribute for a particular member profile may have one or more values. For example, a profile attribute may represent a company and be termed the company attribute. The company attribute in a particular profile may have values representing respective identifications of companies, at which the associated member has been employed. Other examples of profile attributes are the industry attribute and the region attribute. Respective values of the industry attribute and the region attribute in a member profile may indicate that the associated member is employed in the banking industry in San Francisco Bay Area.

An on-line social network system may maintain not only respective profiles of members, but also profiles of organizations, such as companies, universities, etc. For example, a profile of a company may be associated with a company web page and include information about the company. A company web page in the on-line social network system may include a visual control, e.g., a “Follow” button that a user may click to indicate that they would like to “follow” the company profile. A member profile representing a member that “follows” a company profile may include a link indicating this relationship between the member profile and the company profile. This relationship may be expressed in the context of the on-line social network system in that the news and notifications, e.g., regarding job openings at the company, changes in the organization of the company, new members on the executive team, etc., may be communicated to the member associated with the member profile, e.g., via the member's news feed web page, etc.

The on-line social network system also maintains information about job postings. A job posting, also referred to as merely “job” for the purposes of this description, is an electronically stored entity that includes information that an employer may post with respect to a job opening. The information in a job posting may include, e.g., industry, company, job position, required and/or desirable skills, geographic location of the job, etc. As mentioned above, the on-line social network system may be configured to match member profiles with job postings, so that those job postings that have been identified as potentially being of interest to a member represented by a particular member profile are presented to the member on a display device for viewing. The matching of member profiles with the job postings may be accomplished using, e.g., a so-called job recommendation system. The job recommendation system identifies certain job postings as being of potential interest to a member and presents such job postings to the member in order of relevance with respect to the associated member profile.

The jobs that are being of potential interest to a member are selected based on the results of comparing features of the member profile that represents the member (features such as, e.g., job skills, professional seniority, geographic location, etc.) with corresponding features of the respective job postings. All jobs that satisfy a certain criteria with respect to the member profile (e.g., a certain number of the same or similar feature values) are retrieved as a set of recommended jobs.

The number of jobs in the set of recommended jobs may be large, and it may be reasonable include a subset of those on the visible portion of the user's screen. The rest of the jobs can still be available for viewing by scrolling down or paging down the list. The recommendation system may include a so-called relevance calculator to assign respective relevance values to the jobs in the set of recommended jobs and select a certain number of the top-scoring jobs for presentation on the member's display device.

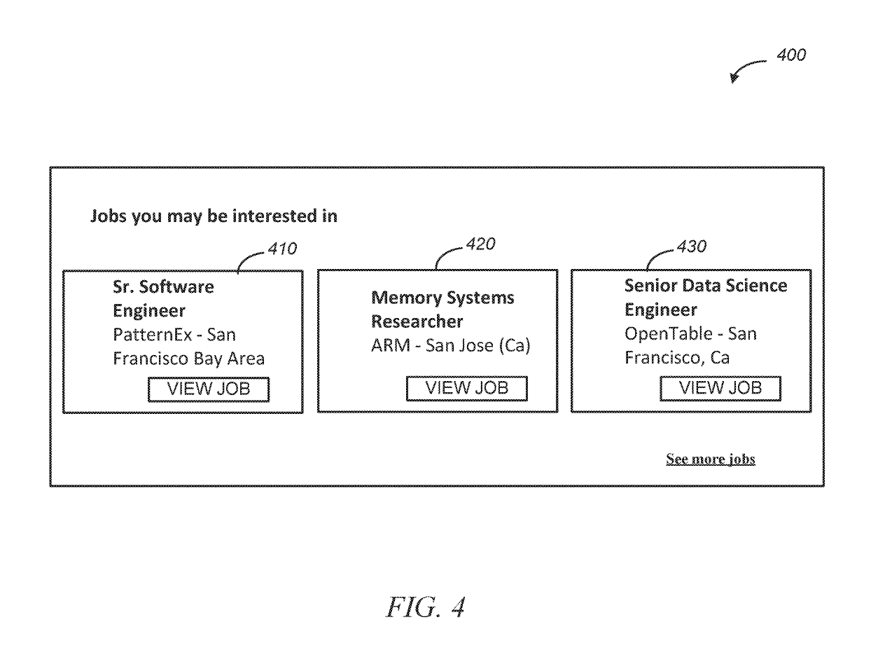

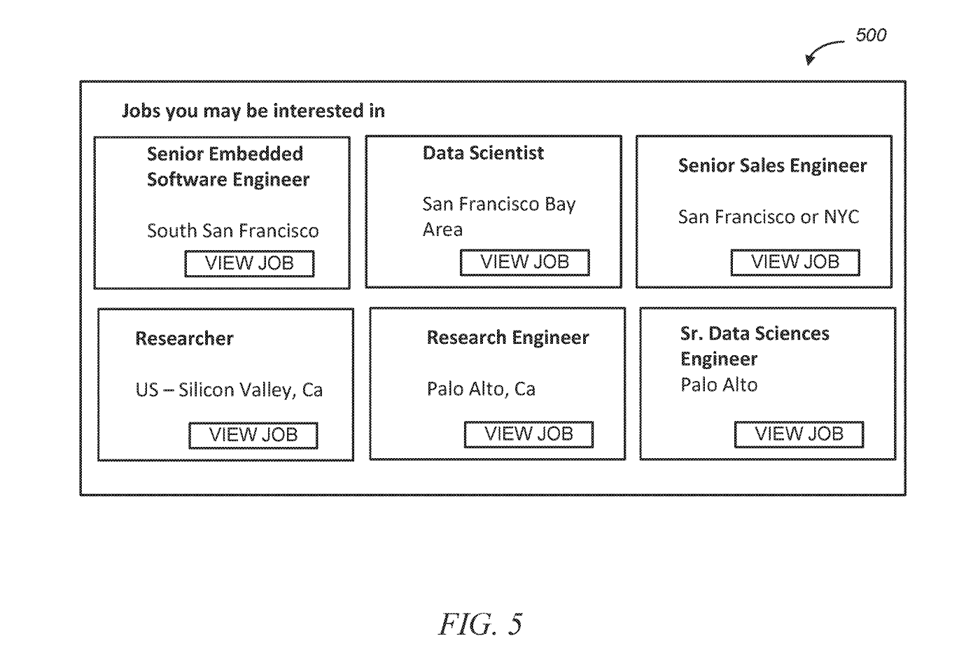

In FIG. 4, for example, a screen 400 representing a portion of a web page shows only three jobs, which have been selected from the set of recommended jobs. The selection of one or more of these jobs can be made based, e.g., on their respective relevance values being the highest among the respective relevance valued assigned to the other jobs in the set of recommended jobs, as well as their respective JPV. The member is provided with an option to see more jobs, here, by activating the “See more jobs” link in the bottom right corner of the screen 400. Activation of the “See more jobs” link causes presentation on a display device of a screen 500 shown in FIG. 5, which includes additional job postings. It can be said that each job presented in the screen 400 is associated with its slot, a so-called recommendation slot. The three jobs presented in the screen 400 are associated with their respective slots 410, 420, and 430. As is described in greater detail below, a web page generator provided as part of or in communication with the recommendation system may place jobs from a set of recommended jobs into the recommendation slots based on the jobs' respective relevance values and/or their respective job poster values.

The job postings that are maintained by the on-line social network system advertise jobs at various organizations (e.g., companies, universities, government-run entities, etc.) referred to, for the purposes of this description, as job poster entities. A job posting entity is typically charged a fee for submitting a job posting to the on-line social network system, which creates an expectation on the part of the job posting entity that the job posting would receive a certain amount of value for the fee that was charged. This value, that may be termed a job poster value, may be affected by the level of interest in the job expressed by qualified members of the on-line social network system. The level of interest may be gauged by the number of applications received with respect to the job posting, the number of views and the number of impressions. For the purposes of this description, a job posting may be referred to as merely a job. A job that has received fewer applications and views after a certain period since it was posted with the on-line social network service may be described as having a higher job poster value. A job that has received a greater number of applications from qualified candidates and a greater number of views after a certain period since it was posted with the on-line social network service may be described as having a lower job poster value. A job poster value (JPV) thus represents a value that is still owed to the job poster (e.g., to the company that posted the job with the on-line social network service) at a certain point in time.

A job poster value calculated for a particular job at a certain point in time may be taken into account when the recommendation system determines which jobs are to be recommended/presented to a member. For example, where each job in a list of recommended jobs retrieved for a particular member are ranked based on their respective relevance values so that only a certain number of top ranked jobs are presented to the member, the respective relevance values may be calculated or adjusted based of the respective JPVs of the recommended jobs. Or, as another example, some of the slots in the slots available for the top ranked jobs may be reserved for those recommended jobs that have the highest JPV, regardless of their respective ranks.

A job poster value may also be used for purposes other than job recommendations. For example, a job poster value can be used to predict which companies or job posting entities are likely to complain about poor performance of their jobs. Some approaches for calculating these predictions are described further below.

The recommendation system may be configured to include, or to cooperate with, a job poster value calculator (a JPV calculator) for determining respective JPVs for jobs and utilizing the respective JPVs to enhance job posters' experience and members' experience with the on-line social network system. While improving a JPV for a job (e.g., by exposing the job to more qualified potential applicants), the poster of the job receives more of the expected value for the job posting, while the members benefit from a better chance of getting the job by applying to jobs with very few or no applications. A JPV calculator can be used beneficially to identify jobs that are of good quality, but not providing sufficient value to the job poster.

In one embodiment, the JPV calculator is configured to determine the JPV for a particular job posting at a particular point in time based on the number of applications received by the job since the time it was posted with the on-line social network system, the number of times the job detail pages have been viewed, and the number of times the job has been shown to members. The JPV calculator also used the information regarding the medium, in which the job recommendation has been displayed: desktop social feed vs desktop jobs home page vs mobile social feed vs mobile jobs home page vs mobile app vs email.

In another embodiment, the JPV calculator is configured to determine the JPV for a particular job posting at a particular point in time based on the number of applications received by the job since the time it was posted with the on-line social network system and the number of impressions, which is the number of times the job has been presented to members. In this embodiment, the job poster value is drawn uniformly at random from a probability distribution (such as, e.g., Beta Distribution), parameterized by the number of applications received for the job at a certain point in time so far and the number of impressions received so far.

The recommendation system may also be configured to include, or to cooperate with, in addition to the JPV calculator, a module for selecting a subset of jobs from a set of recommended jobs based on both the relevance value of the job and on the JPV calculated for that job. Such module, a subset selector, may be configured, e.g., to calculate a combined score for a job recommended for a particular member using both the relevance value of the job and on the JPV calculated for that job.

The JPV calculator determines the job poster value, JPV(j,t), at time t for a job j, by taking into account: (1) the temporal job statistics for job j, which is the number of applications received by the job, the number of times the job detail pages are viewed, and the number of impressions (the number of times the job is shown to members), and (2) the medium m(j), in which the job recommendation is displayed (whether it is, for example, desktop social feed, desktop jobs home page, mobile social feed, mobile jobs home page, mobile app, or email).

In order to calculate JPV(j,t), the JPV calculator takes the following data as input.
Time t.
Set M of media, in which the job is displayed (desktop social feed, desktop jobs home page, mobile social feed, mobile jobs home page, mobile app, or email).
The number of applications, A(j,t,m), received by the job via each medium, m in M.
The number of times the job detail page for job j is viewed, V(j,t,m), via each medium, m in M.
The number of times the job is shown to members, I(j,t,m), via each medium, m in M.

The output of the JPV calculator is the job poster value, JPV(j,t) at time t for a job j. The job poster value JPV(j,t) may be calculated using Equation 1 shown below.

JPV(j,t)=h(f_a({A(j,t,m)|m in M}), f_v({V(j,t,m)|m in M}), f_i({I(j,t,m)|m in M})), Equation(1)

where f_a, f_v, f_i are aggregation functions that give different weights to different media for applications, views, and impressions respectively; and h is a function satisfying the following properties:
h decreases with f_i, that is, job poster value drops as the job is shown to more members
h decreases with f_v, that is, job poster value drops as the job detail page is viewed more
h decreases with f_a, that is, job poster value drops as the job gets more applications
the magnitude of the decrease in h for a unit increase in the inputs is largest for a unit increase in f_a, which is larger than that for a unit increase in f_v, which is larger than that for a unit increase in f_i. In other words, the job poster cares most about applications, followed by job views, and the least about the job being shown to members.

For example, the aggregation function f_a takes, as input, the number of applications received for a particular job via desktop social feed, the number of applications received via desktop jobs home page, the number of applications received via mobile social feed, the number of applications received via mobile jobs home page, the number of applications received via mobile app, and the number of applications received via email. The aggregation function f_a may assign a greater weight to the number of applications received via email than, e.g., to the number of applications received via mobile jobs home page. The resulting aggregated value reflecting (but not necessarily equal to) the total number of applications received for the particular job is used, together with the values determined by using the aggregation functions f_v and f_i to determine the job poster value, JPV(j,t) at time t for a job j.

In one embodiment, the job poster value, JPV(j,t) at time t for a job j is a function g(A(j,t), I(j,t)), where A(j,t) is the number of applications at time t for job j across all media and I(j,t) is the number of impressions at time t for job j across all media. The value returned by the function g decreases with increase in A(j,t), but increases with increase of A(j,t)/I(j,t). In other words, the job poster value is large for jobs that get very few applications, but, at the same time, have a relatively large application-per-impression ratio.

In a further embodiment, the job poster value, JPV(j,t) at time t for a job j equals zero if the number of applications for that job j has reached a certain threshold value. Using g(A(j,t), I(j,t)) as the function to determine JPV(j,t), in this embodiment g(x,y)=0 once x>τ, where τ is a threshold value (such as, e.g., τ=5 applications). When the number of applications at time t for a job j is greater than or equal to τ, A(j,t)<=τ, then the function g(A(j,t), I(j,t)) is defined to be the value of a random variable drawn from Beta(A(j,t)+α, I(j,t)−A(j,t)+β), where α and β are parameters of the Beta distribution, α and β used for smoothing. For example, α and β are parameters can each be set to a constant such as 1. The Beta distribution is a suitable model for the random behavior of proportions. In the above setting, the mean of the random variable g(A(j,t), I(j,t)) is equal to (A(j,t)/I(j,t)), which is the application per impression ratio.

As mentioned above, a job poster value calculated for a particular job at a certain point in time may be taken into account when the recommendation system determines which jobs are to be recommended/presented to a member. For example, the relevance score of the job for a member profile is boosted for jobs getting relatively small number of applications. In one embodiment, where a machine learned model is used to determine the function that combines the relevance score of the job for a member and the job poster value, the function is learned based on a labeled ground truth dataset. In another embodiment, a subset of recommendation slots are reserved for jobs having high job poster value. In yet another embodiment, these slots are chosen at random from amongst the available slots, and the original jobs in those positions are swapped with jobs having high job poster value.

In order to calculate a combined score for a job, based on its JPV and also based on its relevance value, a module of the recommendation system (e.g., a subset selector) takes the following data as input.
Time t
Job poster value, JPV(j,t) at time, t for a job, j
Relevance score, rel(z,j) of job j for member z, which can be determined using a machine learned model that takes into account various features defined between job j and member z and combines these features using model coefficients to obtain the relevance score, rel(z,j)

The output of the subset selector is the combined value, rel_jpv_score(z,j) of job j for member z. The combined value, rel_jpv_score(z,j) of job j for member z may be calculated using Equation 2 shown below.

rel_jpv_score(z,j)=Γ(JPV(j),rel(z,j)) Equation (2)

In one embodiment, Γ(p,q) is a function that is monotonically increasing in both variables. In this embodiment, Γ(JPV(j), rel(z,j)) is monotonically increasing in both variables. In a further embodiment, Γ(p,q) is a function that is learned by applying a machine learning algorithm (such as, e.g., logistic or linear regression) to a labeled around truth dataset.

One example of the function Γ(p,q) for calculating the combined value, rel_jpv_score(z,j) of job j for member z is expressed by Equation 3 shown below.

Γ(p,q)=h1(p)·h2(q), Equation (3)

where h1, h2 are both monotonically increasing functions, e.g., Γ(p,q)=êp·q

Another example of the function Γ(p,q) for calculating the combined value, rel_jpv_score(z,j) of job j for member z is expressed by Equation 4 shown below.

Γ(p,q)=η·h1(p)+(1−η)·h2(q), Equation (4)

where h1, h2 are both monotonically increasing functions, e.g., Γ(p,q)=η·êp+(1−η)·q

In yet another embodiment, as mentioned above, a subset of the recommendation slots could be reserved for jobs having high job poster value, that is, these slots are filled in the decreasing order of job poster value score, JPV(j,t) from amongst jobs that are part of the candidate set of recommended jobs for a given member. Alternatively, these slots may be chosen at random from amongst the available slots, and the original jobs in those positions are swapped with jobs having high job poster value.

As mentioned above, a job poster value may be used for purposes other than job recommendations. For example, a job poster value can be used to predict which companies or job posting entities are likely to complain about poor performance of their jobs. Described below is a methodology for using job poster values calculated for jobs posted by a particular job posting entity to determine an aggregated score for that job posting entity. An aggregated score is calculated for a job posting entity, based on respective JPVs of jobs posted by that job posting entity and it may be referred to as an aggregated job poster value. The aggregated job poster value job for posting entity is calculated as described below.

One example of the function AJPV(X, P, t) for calculating the aggregated job poster value for the job posting entity at time t with respect to jobs satisfying predicate P is expressed by Equation 5 shown below.

AJPV(X,P,t)= [symbol] ({JPV(j,t)|j in J(X,P,t)}), Equation (5)

where [symbol] is an aggregation function that aggregates the job poster value across all jobs from the job posting entity that satisfy the predicate P.

In the Equation 5, X denotes the job posting entity (such as a company, a staffing firm, or a recruiter), and J(X, P, t) denote the set of jobs posted by X that are active at time t, and satisfy predicate P. Some examples of predicate P are listed below.
whether the job corresponds to specific function(s)
whether the job corresponds to specific department(s)
whether the job corresponds to specific seniority levels
whether the job requires specific set of skills
whether the job has salary in a given range
whether the job role is considered to be hard to fill
whether the job is posted before time t′
whether the job is posted after time t″
whether the job is set to expire before time t′″
whether the job is set to expire after time t″″

The aggregated score calculator can compute the aggregated job poster value, AJPV(X, P, t) for the job posting entity at time t with respect to jobs satisfying predicate P taking as input, the following values.
Time t
Predicate P
Set of jobs posted by X that are active at time t, J(X, P, t)

The output generated by the combined score calculator is the aggregated job poster value, AJPV(X, P, t) for the job posting entity at time t with respect to jobs satisfying predicate P. The aggregation function [symbol] shown in the Equation 5 can be chosen according to the application needs. Possible choices are shown below.
Mean or median of overall job poster values
A percentile, such as the lower quartile (Q1) over all the jobs
Mean over the bottom z percentile (that is, the mean for the most poorly performing jobs)

As mentioned above, the aggregated Job poster value AJPV(X, P, t) for the job posting entity at time t with respect to jobs satisfying predicate P can be used to keep track of the job posting entities/companies that may need attention, to diagnose the cause for the poor performance, to compare it with the performance of other peer job posting entities, etc.

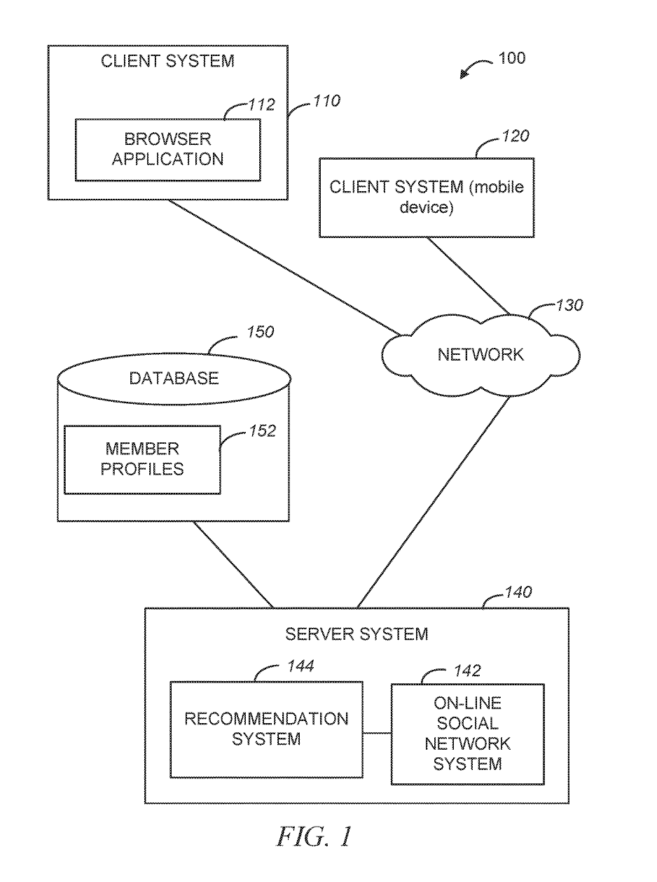

An example recommendation system, configured to include some or all of the functionality described above, may be implemented in the context of a network environment 100 illustrated in FIG. 1. As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

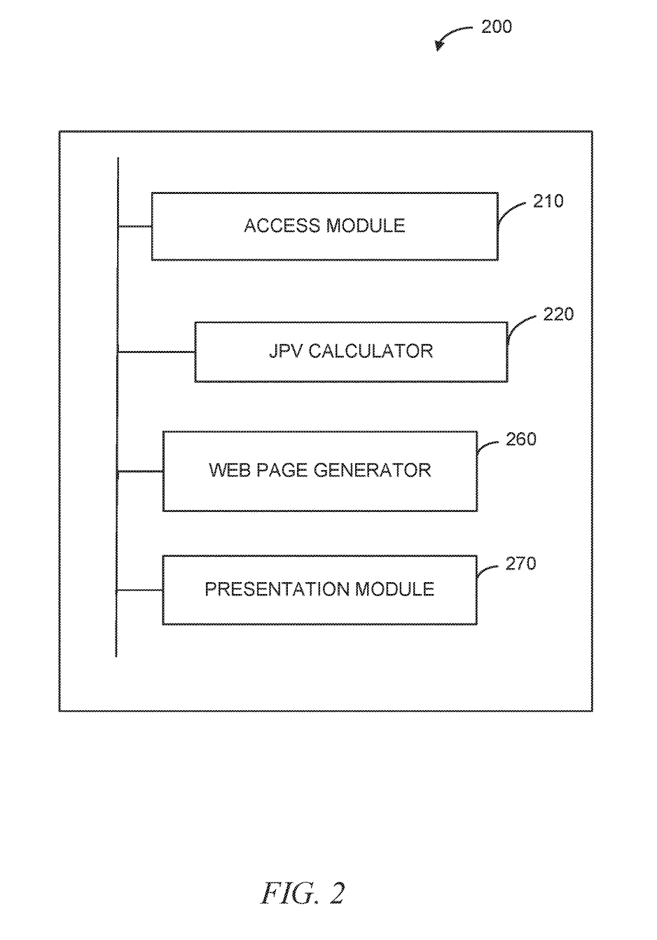

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a recommendation system 144. The recommendation system 144 may be configured to quantify a job poster value for a particular job posting at a certain point in time, in the context of the on-line social network system 142. As described above, a job poster value (JPV) represents a value that is still owed to the associated job posting entity at a certain point in time with respect to a particular job posting. The recommendation system 144 determines JPV by taking into account the temporal job statistics for a job utilizing the methodologies described above. An example recommendation system, which corresponds to the recommendation system 144 is illustrated in FIG. 2.

FIG. 2 is a block diagram of a system 200 to determine a job poster value for a job posting in an on-line social network system 142 of FIG. 1. As shown in FIG. 2, the system 200 includes an access module 210, a job posting value calculator 220, a web page generator 230, and a presentation module 240. The access module 210 is configured to access a job posting maintained in an on-line social network system, the job posting submitted by a job poster entity. The job posting value calculator 220 is configured to determine, for the job posting, a job posting value (JPV) utilizing a number of job applications received with respect to the job posting. The JPV represents a value that is owed to the job poster entity at a certain point in time. The web page generator 230 is configured to generate a web page in the on-line social network system, the web page includes the job posting. The presentation module 240 is configured to cause displaying of the web page on a display device.

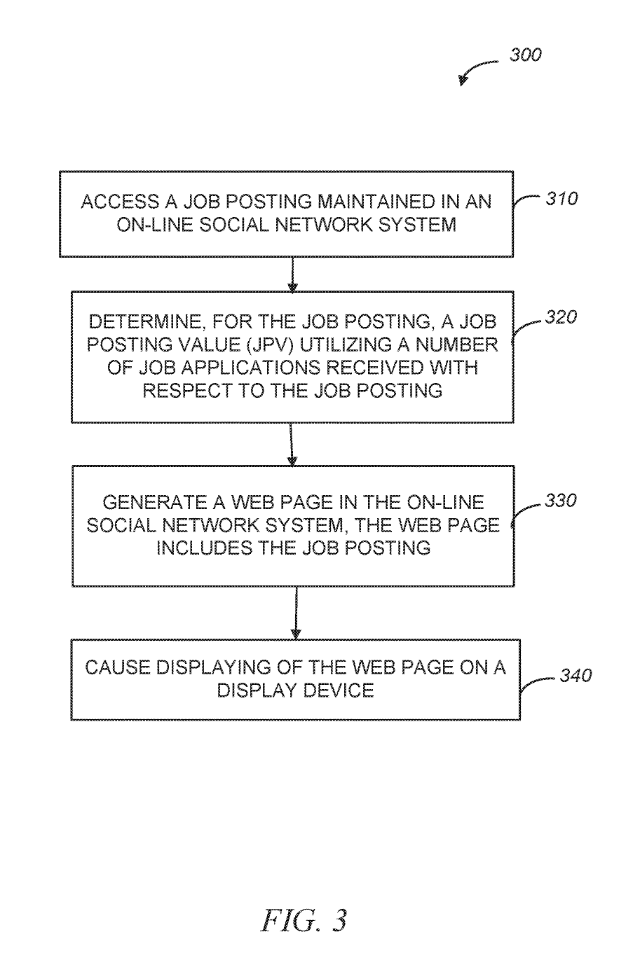

The job posting value calculator 220 may be configured to execute methodologies described above. For example, the job posting value calculator 220 may determine the JPV using a function that decreases with increase of a number of applications received with respect to the job posting. The job posting value calculator 220 may determine the JPV using a function that decreases with increase of a ratio of applications received with respect to the job posting per impressions of the job posting in the on-line social network system. The job posting value calculator 220 may determine the JPV using a function that takes as input a weighted number of applications received with respect to the job posting, a weighted number of views of the job posting, and a weighted number of impressions of the job posting in the on-line social network system. The job posting value calculator 220 may assign a greater weight to the number of applications received with respect to the job posting than to the number of views. As explained above, in some embodiments, the job posting value calculator 220 may assign the JPV the zero value when the number of application received with respect to the job posting has reached a threshold value. The job posting value calculator 220 may determine the JPV as a value of a random variable drawn from Beta distribution with respect to the number of applications received with respect to the job posting and the number of impressions of the job posting in response to determining that a number of applications received with respect to the job posting is below a threshold value. The system 200 may also include a monitor (not shown) to monitor a number of applications received with respect to the job posting, a number of views of the job posting, and a number of impressions of the job posting in the on-line social network system. Some operations performed by the system 200 may be described with reference to FIG. 3.

FIG. 3 is a flow chart of a method 300 to determine a job poster alue for a job posting in an on-line social network system 142 of FIG. 1. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the access module 210 of FIG. 2 accesses a job posting submitted by a job poster entity and maintained in an on-line social network system. The job posting value calculator 220 of FIG. 2 determines, for the job posting, a job posting value (JPV) utilizing a number of job applications received with respect to the job posting, at operation 320. At operation 330, the web page generator 230 of FIG. 2 generates a web page that includes the job posting. The presentation module 240 of FIG. 2 causes displaying of the web page on a display device, at operation 340.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

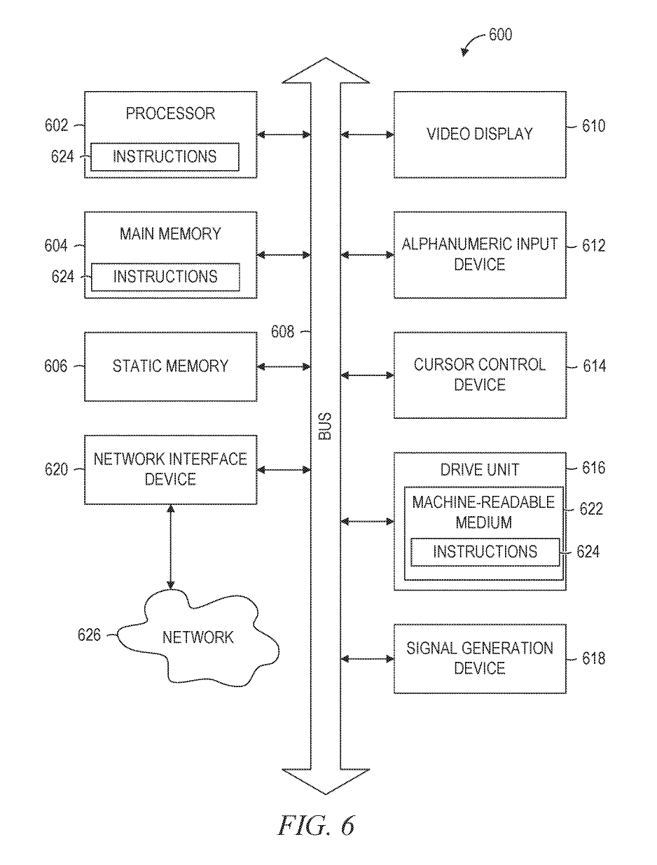

FIG. 6 is a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 606. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMS), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily, configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces e.g., Application Program Interfaces (APIs).)

Thus, a method and system to quantify job poster value in an on-line social network system has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a job posting maintained in an on-line social network system, the job posting submitted by a job poster entity;
for the job posting, using at least one processor, determining a job posting value (JPV) utilizing a number of job applications received with respect to the job posting, the JPV representing a value that is owed to the job poster entity at a certain point in time;
generating a web page in the on-line social network system, the web page includes the job posting; and
causing displaying of the web page on a display device.

2. The method of claim 1, wherein the determining of the JPV comprises using a function that decreases with increase of a number of applications received with respect to the job posting.

3. The method of claim 1, wherein the determining of the JPV comprises using a function that decreases with increase of a ratio of applications received with respect to the job posting per impressions of the job posting in the on-line social network system.

4. The method of claim 1, wherein the determining of the JPV comprises using a function that takes as input a weighted number of applications received with respect to the job posting, a weighted number of views of the job posting, and a weighted number of impressions of the job posting in the on-line social network system.

5. The method of claim 4, wherein the JPV decreases with increase of any of the number of applications received with respect to the job posting, the number of views of the job posting, and the number of impressions of the job posting in the on-line social network system.

6. The method of claim 4, comprising assigning a greater weight to the number of applications received with respect to the job posting than to the number of views.

7. The method of claim 1, wherein the JPV is zero when the number of applications received with respect to the job posting has reached a threshold value.

8. The method of claim 1, comprising:
in response to determining that a number of applications received with respect to the job posting is below a threshold value, determining the JPV as a value of a random variable drawn from Beta distribution with respect to the number of applications received with respect to the job posting and the number of impressions of the job posting.

9. The method of claim 1, comprising monitoring a number of applications received with respect to the job posting, a number of views of the job posting, and a number of impressions of the job posting in the on-line social network system.

10. The method of claim 1, wherein the generating of the web page that includes the job posting is in response to a job search request, the job search request pushed to a member of the on-line social network system or initiated by the member in the on-line social network system.

11. A computer-implemented system comprising:
an access module, implemented using at least one processor, to access a job posting maintained in an on-line social network system, the job posting submitted by a job poster entity;
a job posting value calculator, implemented using at least one processor, to determine, for the job posting, a job posting value (JPV) utilizing a number of job applications received with respect to the job posting, the JPV representing a value that is owed to the job poster entity at a certain point in time;
a web page generator, implemented using at least one processor, to generate a web page in the on-line social network system, the web page includes the job posting; and
a presentation module, implemented using east one processor, to cause displaying of the web page on a display device.

12. The system of claim 11, wherein the job posting value calculator is to determine the JPV using a function that decreases with increase of a number of applications received with respect to the job posting.

13. The system of claim 11, wherein the job posting value calculator is to determine the JPV using a function that decreases with increase of a ratio of applications received with respect to the job posting per impressions of the job posting in the on-line social network system.

14. The system of claim 11, wherein the job posting value calculator is to determine the JPV using a function that takes as input a weighted number of applications received with respect to the job posting, a weighted number of views of the job posting, and a weighted number of impressions of the job posting in the on-line social network system.

15. The system of claim 14, wherein the JPV decreases with increase of any of the number of applications received with respect to the job posting, the number of views of the job posting, and the number of impressions of the job posting in the on-line social network system.

16. The system of claim 14, wherein the job posting value calculator is to assign a greater weight to the number of applications received with respect to the job posting than to the number of views.

17. The system of claim 11, wherein the JPV is zero when the number of application received with respect to the job posting has reached a threshold value.

18. The system of claim 11, wherein the job posting value calculator is to:
in response to determining that a number of applications received with respect to the job posting is below a threshold value, determine the JPV as a value of a random variable drawn from Beta distribution with respect to the number of applications received with respect to the job posting and the number of impressions of the job posting.

19. The system of claim 1, comprising a monitor to monitor a number of applications received with respect to the job posting, a number of views of the job posting, and a number of impressions of the job posting in the on-line social network system.

20. A machine-readable non-transitory storage medium having instruction data executable by a machine to cause the machine to perform operations comprising:
accessing a job posting maintained in an on-line social network system, the job posting submitted by a job poster entity;
for the job posting, determining a job posting value (JPV) utilizing a number of job applications received with respect to the job posting, the JPV representing a value that is owed to the job poster entity at a certain point in time;
generating a web page in the on-line social network system, the web page includes the job posting; and
causing displaying of the web page on a display device.
